(19) United States
(12) Patent Application Publication
(10) Pub. No.: US 2005/0094268 A1
(43) Pub. Date: May 5, 2005

(54) Optical system with birefringent optical elements

(75) Inventors: Damian Fiolka, Oberkochen (DE); Olaf Dittmann, Bopfingen (DE); Michael Totzeck, Schwabisch Gmund (DE); Nils Dieckmann, Huttlingen (DE); Jess Koehler, Immenstaad (DE); Toralf Gruner, Aalen-Hofen (DE); Daniel Kraehmer, Aalen (DE)

Correspondence Address: DARBY & DARBY P.C., P. O. BOX 5257, NEW YORK, NY, 10150-5257, US

(73) Assignee: Carl Zeiss SMT AG, Oberkochen (DE)

(21) Appl. No.: 10/922,380

(22) Filed: Aug. 19, 2004

Related U.S. Application Data
(63) Continuation of application No. PCT/EP02/12446, filed on Nov. 7, 2002.

(30) Foreign Application Priority Data
Mar. 14, 2002 (DE) 102 11 762.4

(51) Int. Cl. G02F 1/1335

(52) U.S. Cl. 359/499

(57) ABSTRACT

An optical system (1) includes a first optical subsystem (3) with at least a first birefringent optical element (7), and further includes a second optical subsystem (5) with at least a second birefringent optical element (9). Between the first optical subsystem and the second optical subsystem, an optical retarding system (13) with at least a first optical retarding element (15) is arranged, which introduces a retardation of one-half of a wavelength between two mutually orthogonal states of polarization.

### CROSS-REFERENCE TO RELATED APPLICATION

This application is a continuation of International Application Serial No. PCT/EP02/12446, filed Nov. 7, 2002 and published in English on Sep. 18, 2003 under the international publication number WO 03/077011, which is still pending, and which claims priority from German Patent Application No. 102 11 762.4, filed Mar. 14, 2002, all of which are hereby incorporated by reference in their entirety.

### BACKGROUND OF THE INVENTION

The invention relates to an optical system with birefringent optical elements.

The birefringent property of the optical elements can be caused, e.g., by stress-induced birefringence, intrinsic birefringence, or by a dependence of the reflectivity on the direction of polarization, as is known to occur in mirrors or in anti-reflex coatings of lenses. Stress-induced birefringence occurs when the optical elements are mechanically stressed or as a side effect of the manufacturing process of the substrate materials for the optical elements.

Systems in which the birefringent property of optical elements has a detrimental influence are, for example, the projection systems used in the field of microlithography.

Projection objectives and projection apparatus are known, e.g., from WO 0150171 A1 (U.S. Ser. No. 10/177,580) and the references cited therein. The embodiments described in that patent application represent purely refractive as well as catadioptric projection objectives with numerical apertures of 0.8 and 0.9 at operating wavelengths of 193 nm as well as 157 nm. The birefringent optical components in these projection objectives lead to a reduced image quality of the projection objectives.

A projection objective with birefringent optical elements is known from DE 19807120 A1 (U.S. Pat. No. 6,252,712). The birefringent optical elements cause optical path differences for two mutually orthogonal states of polarization in a bundle of light rays, where the path differences vary locally within the bundle of light rays. To correct the detrimental influence of the birefringent phenomenon, DE 19907120 A1 proposes the use of a birefringent element with an irregularly varying thickness.

In the not prepublished patent application DE 10127320.7 by the applicant, possibilities for compensating and thereby reducing the detrimental influence of birefringence are presented which include rotating the lenses relative to each other in the case of projection objectives with fluoride crystal lenses. The patent application just mentioned shall hereby be incorporated by reference in the present application.

In the not prepublished patent application DE 10123725.1 by the applicant, possibilities for compensating and thereby reducing the detrimental influence of birefringence are presented, wherein an optical element with a location-dependent property of rotating the polarization state or shifting the optical phase is arranged close to a diaphragm plane. The patent application just mentioned shall hereby be incorporated by reference in the present application.

The birefringent phenomenon also has an undesirable effect in illumination systems of projection systems. The illumination systems may have a light homogenizer in the form of an integrator rod, as described for example in DE 195 48 805 (U.S. Pat. No. 5,982,558). FIG. 2 of the patent application just mentioned illustrates an illumination system with an integrator rod in combination with a laser light source and a catadioptric projection objective. The catadioptric projection objective in this arrangement includes a polarization beam splitter which should be illuminated with linearly polarized light. However, the integrator rod in the illumination system changes the state of polarization of an incident bundle of light rays, e.g., because of stress-induced birefringence in the rod material, intrinsic birefringence, or a phase shift caused by the total reflection inside the rod. It is therefore necessary to use a polarization filter after the integrator rod, which again produces linearly polarized light. However, the polarization filter causes a loss of light intensity.

Illumination systems with an integrator unit that has two integrator rods are known from U.S. Pat. No. 6,028,660.

### OBJECT OF THE INVENTION

The present invention has the objective to propose optical systems with birefringent optical elements employing a simple means for significantly reducing the influence of the birefringent phenomenon.

### SUMMARY OF THE INVENTION

To meet the foregoing objective, the present invention proposes an optical system, an illumination system, a method of producing an optical system, and an optical system that is produced according to one of the methods described herein.

In order to reduce the unwanted influence of the birefringent properties of optical systems, it is proposed to build an optical system from two subsystems with an optical retarding system arranged between the subsystems.

The optical system may, e.g., be an objective, or also a partial objective belonging to the objective. Thus, the objective can be composed of several optical systems that are configured according to the present invention. The objective may, e.g., be a microscope objective or a projection objective for use in projection lithography. The unwanted effects of birefringence are particularly noticeable in objectives where fluoride crystal lenses are used at wavelengths in the deep ultraviolet range (<250 nm). The optical system may also be part of an illumination system, e.g., an integrator unit for generating an illumination with a homogeneous intensity distribution. The integrator unit can likewise have several of the inventive optical systems.

According to the invention, each of the two optical subsystems has at least one birefringent optical element. The birefringent property of an optical element can be due, e.g., to the material properties of the element (intrinsic birefringence), or to extraneous factors (stress-induced birefringence), or to coatings such as anti-reflex coatings or mirror coatings. Examples of optical elements are refractive or diffractive lenses, mirrors, retarding plates, and also include integrator rods.

The optical retarding system includes at least one optical retarding element, which introduces a lag of half of a wavelength between two mutually orthogonal states of polarization. The optical retarding element may be, e.g., a half-wave plate, a birefringent optical element or a coating on an optical element, where the optical element or the coating would be designed to produce an effect corresponding to a half-wave plate. The optical retarding element may be, for example, a fluoride crystal lens or a crystal plate of calcium fluoride in (110)-orientation, where one would make use of the intrinsic birefringence of calcium fluoride or apply a controlled state of stress. Birefringent crystals of magnesium fluoride are suitable for producing the optical retarding element, based on their favorable transmission properties in the deep ultraviolet range, e.g., at 193 nm or 157 nm. It is also possible to use retarding elements made of quartz with a controlled state of stress-induced birefringence, e.g., according to DE 196 37 563 (U.S. Pat. No. 6,084,708). The optical retarding element can also be connected to an adjacent optical element of one of the two subsystems, e.g., by a seamless joint or wringing fit.

Without the optical retarding system, a light ray traversing the birefringent elements in the two subsystems would be subject to an optical path difference for two mutually orthogonal states of polarization. The effects of the two optical subsystems would in this case be cumulative. The retarding system now has the advantageous effect that the two states of polarization are exchanged with respect to each other. As a consequence, the optical path difference caused in the light ray by the first subsystem can be at least partially canceled in the second subsystem.

It is advantageous to arrange in the optical retarding system an additional optical retarding element that introduces a retardation of half of a wavelength between two mutually orthogonal states of polarization. The optical retarding element may be, e.g., a half-wave plate, a birefringent optical element or a coating on an optical element, where the optical element or the coating would be designed to produce an effect corresponding to a half-wave plate. The fast axis of the first optical retarding element should enclose an angle of 45°±10° with the fast axis of the second optical retarding element, 45° being the ideal amount. The term “fast axis” is known from the field of polarization optics. The concept of using two retarding elements that are rotated relative to each other has the advantage that two mutually orthogonal states of polarization of a light ray are exchanged with respect to each other by the optical retarding system and furthermore, that the exchange occurs independently of the state of polarization of the incident light ray. It is therefore possible in a bundle of light rays with different states of polarization to exchange the mutually orthogonal states in all of the rays in the bundle. If all of the light rays of the bundle had the same state of polarization, it would be sufficient to use a single retarding element of appropriate orientation. If two optical retarding elements are used, they can be joined, e.g., by a seamless connection or by a wringing fit.

It is advantageous to divide the optical system into the two optical subsystems in such a manner that a light ray traversing the optical system takes on a first optical path difference ΔOPL₁ for two mutually orthogonal states of polarization while traveling through the first subsystem and then takes on a second optical path difference ΔOPL₂ for two mutually orthogonal states of polarization while traveling through the second subsystem, with the two optical path differences being of similar magnitude. The absolute values of the two optical path differences should deviate from each other by less than 40%, wherein this number refers to the maximum value of the two optical path differences. In this case, the compensating effect on the unwanted influence of birefringence will be particularly favorable, because the two mutually orthogonal states of polarization of a light ray take on a first optical path difference in the first subsystem, are then exchanged by the retarding system, and subsequently take on a second optical path difference in the second subsystem, where the first and second optical path differences have equal absolute amounts but opposite signs. Consequently, the resulting optical path difference is significantly smaller than in an optical system without a retarding system.

The polarizing effects of the two optical subsystems can also be described through Jones matrices. The definition of the concept of Jones matrices is known from the field of polarization optics. Using this approach, a Jones matrix can be calculated for each of the two optical subsystems to describe the polarizing effects of the two optical subsystems on the mutually orthogonal states of polarization of a light ray traversing the optical system. Commercially available software programs are available for the calculation of the Jones matrices, such as for example CodeV® by Optical Research Associates, Pasadena, Calif., USA. It is advantageous to normalize the Jones matrix of a subsystem with its determinant. However, other normalizations are also possible. The compensation of the unwanted influence of birefringence by means of the retarding system is particularly successful if the coefficients of the normalized Jones matrices of the two subsystems agree with each other as much as possible. The absolute values of the corresponding matrix coefficients should deviate from each other by less than 30%, wherein this number refers to the maximum value of the two corresponding matrix coefficients. In this case, a light ray traversing the optical system will not be subjected to an optical path difference between two mutually orthogonal states of polarization. However, it is possible that the two states of polarization will be exchanged, depending on the nature of the birefringent optical elements.

If one considers an entire bundle of light rays, the optical system can be divided into two optical subsystems in such a manner that the distribution profile of the optical path differences for two mutually orthogonal states of polarization will show significantly reduced values in comparison to an optical system without a retarding system. The values are considered to be significantly reduced if the maximum value in the distribution profile of the optical path differences with the retarding system amount to no more than 50% of the maximum value observed without the retarding system.

The invention can be advantageously used in an integrator unit for generating an illumination with a homogenous intensity distribution. In this embodiment of the invention, the integrator unit consists of at least two integrator rods that are arranged in series. The integrator rods can have birefringent properties, for example stress-induced birefringence caused by the holder arrangement for the integrator rods, or intrinsic birefringence inherent in the rod material itself, or birefringence caused by total reflection at the lateral surfaces of the rods. A birefringent effect also occurs in an integrator rod that is configured as a light pipe, if the rays are split into differently polarized components at the mirror-coated lateral surfaces. As a consequence of the birefringent effect of the integrator rods, the state of polarization of a bundle of rays is altered inside the integrator unit. As an example, if the integrator unit is used in an illumination system for a catadioptric projection objective with a polarization beam splitter, it is desirable if the integrator unit changes the state of polarization of a bundle of light rays only within narrow limits. By inserting the retarding system between the two integrator rods, it is possible to significantly reduce the unwanted influence of birefringence.

As a condition that the optical path differences for two mutually orthogonal states of polarization caused by the two rod integrators will to a large extent compensate each other, it is advantageous if the two integrator rods have nearly identical dimensions. More specifically, the lengths and cross-sectional areas of the two integrator rods should differ from each other by less than 30%, wherein this number refers to the maximum values of the corresponding lengths and cross-sectional areas.

At wavelengths in the deep ultraviolet range, particularly at 193 nm and 157 nm, fluoride crystals such as, e.g., calcium fluoride, are used as raw material for the rods because of their higher transmissivity. In this case, the angle-dependent intrinsic birefringence of the fluoride crystals is felt as a noticeable inconvenience. In a favorable arrangement, both integrator rods consist of the same kinds of fluoride crystals, and the fluoride crystals in the two integrator rods have equivalent crystallographic orientations. As an example, the longitudinal axes of the two integrator rods can be aligned with a principal crystallographic direction, e.g., in the <100>- or <111>-direction. The principal crystallographic directions of cubic crystals, i.e., the class that includes fluoride crystals, are <110>, <\overline{1}10>, <\overline{1}\overline{1}0>, <101>, <10\overline{1}>, <\overline{1}01>, <\overline{1}0\overline{1}>, <011>, <0\overline{1}1>, <01\overline{1}>, <0\overline{1}\overline{1}>, <111>, <\overline{1}\overline{1}\overline{1}>, <\overline{1}\overline{1}1>, <\overline{1}1\overline{1}>, <1\overline{1}\overline{1}>, <\overline{1}11>, <1\overline{1}1>, <11\overline{1}>, <100>, <010>, <001>, <\overline{1}00>, <0\overline{1}0> und <00\overline{1}> auf. For example, the principal crystallographic directions <100>, <010>, <001>, <\overline{1}00>, <0\overline{1}0> und <00\overline{1}> are equivalent to each other, because of the symmetries of cubic crystals, so that any statements made in reference to one of the aforementioned crystallographic directions will also be valid for the other, equivalent crystallographic directions.

It is advantageous to provide an arrangement whereby the clamping force of a mounting device of an integrator rod can be varied. This offers the possibility to vary the stress-induced birefringence inside the integrator rod and to thereby improve the compensation.

If the optical retarding system in the integrator unit consists of only a single optical retarding element, it is advantageous if the fast axis of the optical retarding element encloses an angle of 45°±5° with one of the edges of a rod-integrator surface facing the optical retarding system. When used in connection with integrator rods consisting of fluoride crystal material whose <100> axis is aligned in the direction of the longitudinal axes of the integrator rods, this arrangement provides a high degree of compensation of the unwanted effects of intrinsic birefringence.

If one uses two retarding elements rotated at 45° in relation to each other in the integrator unit, it is possible to also use other crystallographic orientations. In this case, it is advantageous if the optical path difference for two mutually orthogonal states of polarization in a light ray traversing the first integrator rod is of nearly equal magnitude as for the same light ray traversing the second integrator rod.

An optical retarding system in an integrator unit can also be arranged within an image-projecting system, which projects the exit surface of the first integrator rod onto the entry surface of the second integrator rod. The image-projecting system in this arrangement consists of a first and second optical device portion with the optical retarding system arranged between the first and second optical device portion. The first optical subsystem is now composed of the first integrator rod and the first optical device portion, and the second optical subsystem is composed of the second integrator rod and the second optical device portion. If the first and second optical device portions themselves include birefringent optical elements, it is advantageous if the optical path difference for two mutually orthogonal states of polarization in a light ray traversing the first optical device portion is of nearly equal magnitude as for the same light ray traversing the second optical device portion.

The integrator unit of the foregoing description is used to particular advantage in an illumination system within a projection apparatus.

The invention can further be used to advantage, if the optical system is an objective that projects an object plane onto an image plane. The optical system can also be represented by a partial objective of an image-projecting objective, or it can be one of several partial objectives within an image-projecting objective.

The compensation leads to a noticeable reduction of the unwanted effects caused by birefringence, if the optical path differences for two mutually orthogonal states of polarization are calculated for an entire bundle of light rays in the first and second optical subsystem. The light rays of the bundle will pass through the diaphragm plane of the objective for example in an even distribution. The calculated path differences for each optical subsystem will follow a respective distribution profile whose respective maximum absolute value can be determined. The optical retarding system is advantageously arranged at a position within the objective where the maximum absolute value of the first distribution profile deviates by no more than 40% from the maximum absolute value of the second distribution profile.

Likewise, the respective Jones matrices of the first and second optical subsystem can be calculated for each light ray in a bundle of rays. Each ray will thus have eight Jones coefficients in the two optical subsystems, four of which will correspond to each other in each case. Based on the values of the mutually corresponding Jones coefficients, the values of the differences are established for each ray. The birefringence effects can be advantageously corrected, if the maximum among the values of the differences is smaller than 30% of the maximum of the amounts of the Jones coefficients of the first Jones matrices.

The invention can be used advantageously in an objective that has at least one fluoride crystal lens in each of the two optical subsystems, where the lens axis is oriented in a principal crystallographic direction of the fluoride crystal. The lens axes are considered to be oriented in a principal crystallographic direction if the maximum deviation between lens axis and principal crystallographic direction is less than 5°. The lens axis in this case is represented, e.g., by the axis of symmetry of a rotationally symmetric lens.

If the lens has no axis of symmetry, the lens axis can be defined by the central ray of an incident bundle or by a straight line in relation to which the angles of all rays within the lens are minimal. The range of lenses that can be considered includes, e.g., refractive or diffractive lenses as well as corrective plates with free-form corrective surfaces. Planar-parallel plates, too, are considered as lenses, if they are arranged in the light path of the objective. The lens axis of a planar-parallel plate runs perpendicular to the plane surfaces of the plate. Since each of the two optical subsystems contains a fluoride crystal lens in a given orientation, the unwanted influence of one lens can be compensated by the other lens, because the optical retarding system exchanges the two states of polarization against each other. It is particularly favorable if the two lenses consist of the same fluoride crystal material and the lens axes are oriented in the same crystallographic direction or in equivalent crystallographic directions.

The optical retarding system with at least one optical retarding element can be advantageously combined with other birefringence-compensating methods that are described in the not pre-published patent applications DE 10127320.7 and DE 10123725.1, whose entire content is included by reference in the present application. In particular, the unwanted influence of birefringence can already be noticeably reduced with fluoride crystal lenses whose lens axes are oriented in the same principal crystallographic direction by rotating the fluoride crystal lenses relative to each other. A further reduction of the unwanted influence of birefringence can be achieved through the additional use of a birefringence compensator consisting of a birefringent lens with a location-dependent thickness profile in the area of the diaphragm plane of an image-projecting objective.

In objectives, a retarding element of the retarding system can be realized by applying a retardant coating to an optical element that belongs to the first or second subsystem where the retardant coating is designed to effect a retardation by one-half of a wavelength. This is possible, e.g., with a magnesium fluoride coating in which the birefringent effect is achieved through the vapor-deposition angle in the production process of the coating. The retarding element belongs therefore to the first or second subsystem and to the retarding system.

If the numerical aperture of the objective on the image side is larger than on the object side, it is advantageous to place the optical retarding system between the diaphragm plane of the objective and the image plane of the objective. The reason why this arrangement is preferred is that large angles of incidence at air/glass interfaces and large angles of the light rays inside the lenses, which occur in the optical elements near the image plane, lead to large optical path differences between two mutually orthogonal states of polarization. For the compensation of the path differences, it is therefore necessary to also include in the first subsystem some of the lenses that are positioned in the light path after the diaphragm plane, i.e., lenses that are between the diaphragm plane and the image plane.

The invention also proposes a method of producing an optical system in which the birefringent effects are compensated. The configuration and in particular the number n of optical elements of the optical system are given factors known at the outset. However, the compensation will only be successful if the optical system includes at least two birefringent optical elements. The objective of the inventive method is to find the number m of consecutively adjacent optical elements that are to be assigned to the first subsystem, where the remaining number n−m of consecutively adjacent optical elements will make up the second subsystem. Having determined the respective elements for the first and second subsystems, one will achieve a noticeable reduction of the unwanted influence of birefringence by inserting the optical retarding system between the first and second optical subsystems. A plurality of steps are proposed under the method, as follows:
A: Setting up a first optical subsystem of m consecutively adjacent optical elements, where m is less than n.
B: Setting up a second optical subsystem of n−m consecutively adjacent optical elements.
C: Calculating the first normalized Jones matrix T₁ for the first optical subsystem with the coefficients T_{1,xx}, T_{1,xy}, T_{1,yx}, and T_{1,yy} describing the effect of the first optical subsystem on a light ray traveling through the optical system.
D: Calculating the second normalized Jones matrix T₂ for the second optical subsystem with the coefficients T_{2,xx}, T_{2,xy}, T_{2,yx}, and T_{2,yy} describing the effect of the second optical subsystem for the same light ray.
E: Calculating the differences ΔTₓₓ, ΔT_{xy}, ΔT_{yx}, and ΔT_{yy} between the values of the corresponding coefficients.
F: Repeating the steps A through E for all values of m between 1 and n−1.
G: Determining the value m₀ for which the values of the differences ΔTₓₓ, ΔT_{xy}, ΔT_{yx}, and ΔT_{yy} are minimal.
H: Inserting an optical retarding system between the first optical subsystem of m₀ consecutively adjacent optical elements and the second optical subsystem of n−m₀ consecutively adjacent optical elements, where the optical retarding system has at least a first optical retarding element introducing a retardation of half of a wavelength between two mutually orthogonal states of polarization.

It is advantageous to perform the calculation in steps C and D of the method for several light rays. In an image-projecting objective, the light rays can, for example, come from one object point and pass through the diaphragm plane at evenly distributed locations.

It is also possible
to calculate in step C instead of the Jones matrix T₁ a first optical path difference ΔOPL₁ for two mutually orthogonal states of polarization for a light ray traveling through the first subsystem,
to calculate in step D instead of the Jones matrix T₂ a second optical path difference ΔOPL₂ for two mutually orthogonal states of polarization for the same light ray traveling now through the second subsystem,
to calculate in step E the difference ΔOPL between the absolute value of the first optical path difference ΔOPL₁ and the absolute value of the second optical path difference ΔOPL₂,
to determine in step G the value m₀ for which the value of the difference ΔOPL is minimal.

The following variant of the method can likewise be advantageously used for producing an optical system. It has the following steps:
A: Setting up a first optical subsystem of m consecutively adjacent optical elements, where m is less than n, and where the m optical elements include the first birefringent optical element.
B: Setting up a second optical subsystem of n−m consecutively adjacent optical elements, where the n−m optical elements include the second birefringent optical element.
C: Calculating the first normalized Jones matrix T₁ for the first optical subsystem with the coefficients T_{1,xx}, T_{1,xy}, T_{1,yx}, and T_{1,yy} describing the effect of the first optical subsystem on a light ray traveling through the optical system.
D: Calculating the second normalized Jones matrix T₂ for the second optical subsystem with the coefficients T_{2,xx}, T_{2,xy}, T_{2,yx}, and T_{2,yy} describing the effect of the second optical subsystem on the same light ray.
E: Calculating the differences ΔTₓₓ, ΔT_{xy}, ΔT_{yx}, and ΔT_{yy} between the values of the corresponding coefficients.
F: If one of the differences exceeds a prescribed threshold value, determining a new starting value m and repeating steps A through
E. Otherwise, if all differences are below the prescribed threshold value, proceeding to the next step.
G: Inserting an optical retarding system between the first optical subsystem of m₀=m consecutively adjacent optical elements and the second optical subsystem of n−m₀ consecutively adjacent optical elements, where the optical retarding system introduces a retardation of half of a wavelength between two mutually orthogonal states of polarization.

The foregoing method does not require the calculation of the Jones matrices for every value m between 1 and n−1. The optimization process is finished after a solution has been found for the system where the differences of the Jones coefficients are below a prescribed threshold value or target value. The optical system determined in this manner meets the prescribed criterion in regard to unwanted birefringence effects. If no value can be found for m so that the differences are less than the threshold value, one will have to raise the threshold value. In this case, it needs to be evaluated whether the optical system can meet the requirements that were specified for the optical system. If the requirements cannot be met, one will have to change the optical design of the optical system, the choice of materials, or the technique of mounting the optical elements.

It is also possible in a variant of the last mentioned method
to calculate in step C instead of the Jones matrix T₁ a first optical path difference ΔOPL₁ for two mutually orthogonal states of polarization for a light ray traveling through the first subsystem,
to calculate in step D instead of the Jones matrix T₂ a second optical path difference ΔOPL₂ for two mutually orthogonal states of polarization for the same light ray traveling now through the second subsystem,
to calculate in step E the difference ΔOPL between the absolute value of the first optical path difference ΔOPL₁ and the absolute value of the second optical path difference ΔOPL₂,
to amend step F in the following way: If the difference ΔOPL exceeds a prescribed threshold value, determining a new starting value m and repeating steps A through E. Otherwise, if the difference ΔOPL is below the prescribed threshold value, proceeding to the next step.

The optical systems produced according to either of the aforedescribed methods show noticeably less of the undesirable effect of birefringence. The improvement has been achieved by taking a simple measure, namely by inserting one or two retarding elements, each of which causes a retardation of one-half of a wave length in a light ray with two mutually orthogonal states of polarization. By inserting simple half-wave plates, one can in many cases dispense with the use of complicated birefringence compensators or improve the effectiveness of a compensators by additionally using half-wave plates.

### BRIEF DESCRIPTION OF THE DRAWINGS

The invention will be explained in more detail below, making reference to the drawings, wherein:

FIG. 1 represents a schematic view of an optical system according to the invention;

FIG. 2 represents a schematic three-dimensional view of a retarding system according to the invention;

FIG. 3 represents a schematic side view of an integrator unit;

FIG. 4 represents a schematic side view of an integrator unit together with the holder devices;

FIG. 5 represents a schematic side view of an illumination system according to the invention;

FIG. 6 represents a schematic side view of an integrator unit with an interposed optical image-projecting arrangement;

FIG. 7 represents a sectional view of a catadioptric projection objective; and

FIG. 8 represents a schematic side view of a projection apparatus.

### DETAILED DESCRIPTION OF PREFERRED EMBODIMENTS

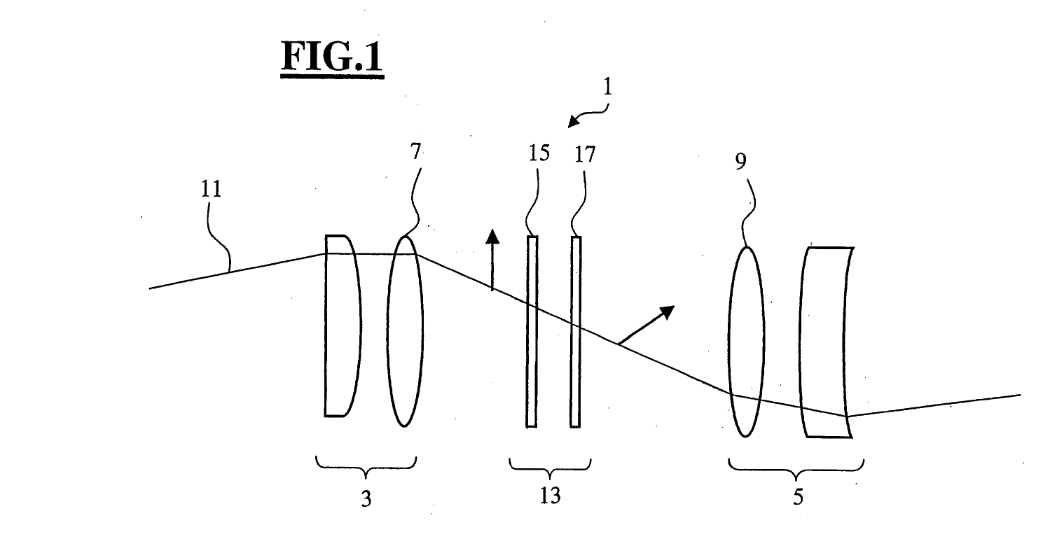

FIG. 1 shows an optical system according to the invention in a schematic representation which will serve to explain the function of the invention. The subject illustrated in FIG. 1 is an optical system 1 consisting of two optical subsystems 3 and 5. Each of the subsystems 3 and 5 contains at least one birefringent optical element, shown as 7 and 9, respectively. The birefringent effect can be caused, e.g. by intrinsic birefringence or stress-induced birefringence. A light ray 11 is characterized by its state of polarization, which can always be divided into two mutually orthogonal states of polarization. The state of polarization of each light ray can be described through a two-dimensional Jones vector. The two components of the Jones vector indicate the complex amplitudes of the electrical field strength in two mutually ortogonal directions. The effect that the optical system 1 has on the state of polarization of a light ray is described by a two-dimensional matrix that interacts with the Jones vector, i.e., the Jones matrix J.

$$J = ( \begin{matrix}{J}_{11} & {J}_{12} \\ {J}_{21} & {J}_{22}\end{matrix} ) \qquad ( 1 )$$

The Jones matrix of a known polarization-optics system or subsystem can be determined with the optics software program Code V®. The Jones matrix can be determined in two steps. For this example, we consider a basis of linear polarization states which are mutually orthogonal. However, any set of two mutually orthogonal states can in principle be used. In the first step of the computation process, the calculations are performed for a light ray having a first state of linear polarization. The Jones vector at the exit of the system is in this case equal to the first column of the Jones matrix. The second column is obtained in a second step by considering a light ray having a second state of linear polarization which is orthogonal to the first state of polarization. Furthermore, since only the optical effect on the polarization is relevant, it is advantageous to normalize the Jones matrix with a suitable normalization basis. A suitable basis is represented, e.g., by the determinant. Only Jones matrices normalized in this manner will be used hereinafter. If the individual Jones matrices of the optical subsystems 3 and 5 of the optical system 1 are known, the Jones matrix of the optical system 1 can be calculated as the multiplication product of the individual Jones matrices.

If the optical system 1 is subdivided into two optical subsystems 3 and 5 with nearly identical Jones matrices, a compensation of the unwanted influence of birefringence can be achieved by inserting a retarding system 13, hereinafter referred to as a 90°-rotator. The 90°-rotator 13 is arranged between the two optical subsystems 3 and 5. To give an intuitive explanation, the path difference that has been accumulated between the two mutually orthogonal states of polarization of a light ray during its passage through the first optical subsystem 3 is subsequently reversed and thereby canceled as the same light ray passes through the second optical subsystem 5. After the light ray has passed through the 90°-rotator 13, the two components of the Jones vector are exchanged with respect to each other and in addition, the sign of one of the two vector components is inverted. The Jones matrix R of a 90°-rotator is therefore:

$$R = \pm ( \begin{matrix}0 & - 1 \\ 1 & 0\end{matrix} ) \qquad ( 2 )$$

With T designating the Jones matrix of each of the two nearly identical optical subsystems 3 and 5, and R designating the Jones matrix of the 90°-rotator 13, the Jones matrix J for the overall system after inserting the 90°-rotator 13 is obtained by the following calculation:

$$\begin{matrix}J = TRT = \frac{1}{\sqrt{2}} ( \begin{matrix}{T}_{xx} & {T}_{xy} \\ {T}_{yx} & {T}_{yy}\end{matrix} ) ( \begin{matrix}0 & - 1 \\ 1 & 0\end{matrix} ) ( \begin{matrix}{T}_{xx} & {T}_{xy} \\ {T}_{yx} & {T}_{yy}\end{matrix} ) & ( 3 ) \\ J = ( \begin{matrix}{T}_{xx} ( {T}_{xy} - {T}_{yx} ) & {T}_{xy}^{2} - {T}_{xx} {T}_{yy} \\ {T}_{xx} {T}_{yy} - {T}_{yx}^{2} & {T}_{yy} ( {T}_{xy} - {T}_{yx} )\end{matrix} ) & ( 4 )\end{matrix}$$

A compensation of the system is achieved if the Jones matrix of the optical system 1 does not mix the components of the Jones vector of the incident light ray 11 and does not weaken one component in relation to the other. An attenuation that is equally shared by both components can be corrected by scalar means such as gray filters and thus will likewise lead to a compensation of the undesirable polarization-related properties. In this case, the Jones matrix takes on one of the forms

$$\begin{matrix}J = p [ \begin{matrix}\pm 1 & 0 \\ 0 & \pm 1\end{matrix} ] or & ( 5 ) \\ J = p [ \begin{matrix}0 & \pm 1 \\ \pm 1 & 0\end{matrix} ] & ( 6 )\end{matrix}$$

In general, p will be a scalar complex amplitude factor, including the special case of a pure phase. The compensation can be achieved, e.g., in a first case where T is a symmetric matrix, i.e., T_{xy}=T_{yx}. This applies, e.g., for
a single retarding element such as, e.g., a single lens of CaF₂ with an arbitrary orientation, a mirror, a half-wave plate, or a quarter-wave plate,
a combination of lenses of equivalent orientation made of a birefringent material such as CaF₂. In this context, two lens orientations are called equivalent, if there is no difference between them in regard to their polarizing effect. An example of this would be two lenses whose lens axes are oriented in the crystallographic direction <111> and whose crystallographic directions <100> are oriented at an angle of n×120° from each other, where n is a positive integer.

Compensation can further be achieved if T is a unitary matrix, i.h. T⁻¹=T^{T}. In this case, the factor P is a pure phase. This applies, e.g., for
a combination of several CaF₂ lenses that are oriented differently,
a combination of retarding plates that are oriented differently,
a combination of birefringent lenses, mirrors and retarding plates,
elements subjected to additional stress in the form of an intentionally applied controlled stress, or a material-related stress, or a mounting-related stress.

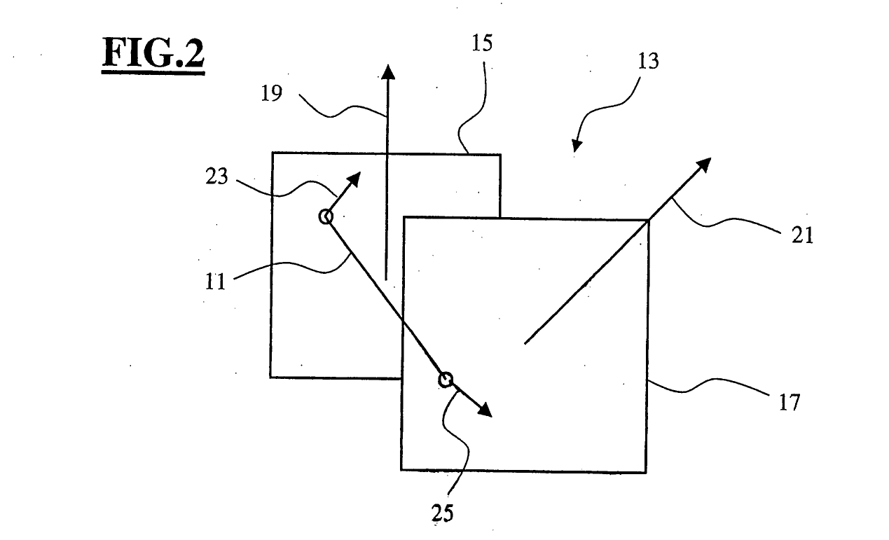

The following description relates to an embodiment of the 90°-rotator 13. The 90°-rotator 13 is obtained by combining two half-wave plates 15 and 17 that are rotated by 45° relative to each other. A schematic view of the two half-wave plates 15 and 17 is shown in FIG. 2. The fast axes of the two half-wave plates are identified with 19 and 21. The direction of polarization 23 of the light ray 11 before entering the 90°-rotator 13 is turned by 90° by the 90°-rotator 13 so that after the 90°-rotator 13, the previous polarization direction 23 has been turned into the polarization direction 25.

The Jones matrix R of the 90°-rotator 13 can be obtained by the following mathematical derivation. Two half-wave plates whose fast axes enclose an angle α are equivalent to a rotator with a rotation angle of 2α.

$$( \begin{matrix}1 & 0 \\ 0 & - 1\end{matrix} ) ( \begin{matrix}cos α & sin α \\ - sin α & cos α\end{matrix} ) ( \begin{matrix}1 & 0 \\ 0 & - 1\end{matrix} ) ( \begin{matrix}cos α & - sin α \\ sin α & cos α\end{matrix} ) = ( \begin{matrix}{cos}^{2} α - {sin}^{2} α & - 2 cos α sin α \\ 2 cos α sin α & {cos}^{2} α - {sin}^{2} α\end{matrix} ) = ( \begin{matrix}cos ( 2 α ) & - sin ( 2 α ) \\ sin ( 2 α ) & cos ( 2 α )\end{matrix} ) \qquad ( 7 )$$

As the result of the equation shows, an angle α=45° produces a 90°-rotator.

The two half-wave plates 15 and 17 can be realized in different ways. To name one possibility, the two border surfaces of the two optical subsystems 3 and 5, e.g., lens surfaces, which are facing towards the 90°-rotator can be coated with a retardant coating of MgF₂ that is applied to the surfaces under specific vapor-deposition angles and effects a retardation by one-half of a wavelength. It is alternatively possible to install conventional half-wave plates between the two subsystems As a material for the half-wave plates, one can use a birefringent magnesium fluoride or calcium fluorids in <110>-orientation at a wavelength of 157 nm.

In a first embodiment, the invention is used in a rod integrator of the kind used in an illumination system for a projection apparatus. Illumination systems of this type are known from DE 195 48 805 A1 (U.S. Pat. No. 5,982,558).

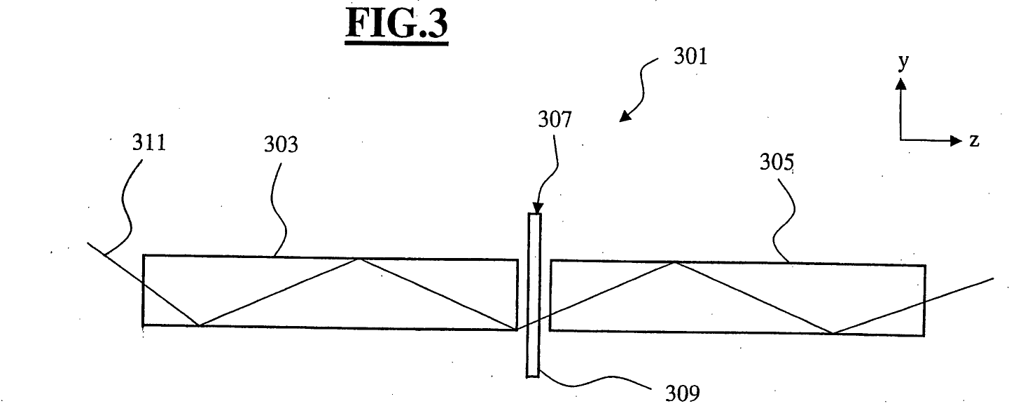

As an example of an optical system in which the unwanted influence of birefringence is compensated, FIG. 3 gives a schematic view of an integrator unit 301 consisting of a first integrator rod 303 and a second integrator rod 305. Arranged between the integrator rods is an optical retardation system 307. The two integrator rods 303 and 305 have the same dimensions. The longitudinal axes of the two integrator rods are aligned in the z-direction, and their cross-sectional dimensions extend in the x- and y-directions. The optical retarding system consists of a single half-wave plate (λ/2-plate) 309 whose fast axis is inclined at 45° to the x-axis.

A first unwanted effect of birefringence is due to the reflection on the side surfaces. A light ray 311 passing through the first integrator rod 303 will be reflected n times, where n could be any positive integer. At each reflection, the optical path difference in the light ray 311 between a first state of polarization E₁ and a second state of polarization E₂ that is orthogonal to E₁ will have grown by a certain amount. For example in the state E₁, the light ray may have a linear polarization in the direction perpendicular to the plane of incidence of the light ray. Accordingly, for the state E₂, the direction of polarization lies in the plane of incidence. Due to the increase of the optical path difference at each reflection, the optical integrator rod 303 will introduce an optical path difference ΔOPL₁ between the states of polarization E₁ and E₂. The half-wave plate 309 rotates the directions of the two states of polarization E₁ and E₂ by 90°, so that the states of polarization E₁ and E₂ of the light ray 311 are in effect exchanged with respect to each other. Thus, if the state E₁ has an optical path difference in comparison to the state E₂ after the first integrator rod 303, the optical path difference between the states E₁ and E₂ will decrease again at each reflection in the second integrator rod 305. As a result of the reflections in the second integrator rod 305, the light ray 311 will be subjected to an optical path difference ΔOPL₂ between the states of polarization E₁ and E₂. The optical path difference ΔOPL₂, however, has the opposite sign of ΔOPL₁. Therefore, if the number of reflections in the first integrator rod 303 is the same as in the second integrator rod 305, the cumulative optical path difference ΔOPL over the two integrators will be compensated because ΔOPL₂=−ΔOPL₁. Since the number of reflections in the second integrator rod 305 can only be n−1, nor n+1, there can be no perfect compensation.

In addition to the birefringent effect of the reflections on the side surfaces, the intrinsic birefringence of the rod material also causes optical path differences in a light ray 311 between a first state of polarization E₁ and a second state of polarization E₂ that is orthogonal to E₁. The intrinsic birefringence of fluoride crystals such as, e.g., calcium fluoride, which is the material of the integrator rods 303 and 305, is associated with a characteristic spatial arrangement of the slow crystallographic axes and amounts at most to about 11 nm/cm at a wavelength of 157 nm. It is possible to calculate the change in the state of polarization that the intrinsic birefringence of calcium fluoride causes in a light ray and to develop a compensation arrangement. It is advantageous if the symmetry of the distribution of the slow axes matches the fourfold symmetry of the integrator rods. Accordingly, it is of advantage if the longitudinal axes of the integrator rods 303 and 305 are aligned with the crystallographic direction <100>. In the arrangement shown in FIG. 3, where the integrator rods 303 and 305 are of equal length, the optical light paths in the two integrator rods 303 and 305 for any light ray are nearly equal in length. On a path through the first integrator rod 303, an optical path difference builds up between the two states of polarization E₁ and E₂. The half-wave plate 308 rotates the directions of the two states of polarization E₁ and E₂ by 90°, so that the states of polarization E₁ and E₂ in the light ray 311 are in effect exchanged with respect to each other. The second integrator rod 305 will now cause a nearly equal change of the state of polarization as occurred in the first integrator rod 303. The change in the polarization of the light ray due to intrinsic birefringence is therefore to a large extent compensated. Consequently, there is almost no resultant optical path difference between the states of polarization E₁ and E₂.

In a specific practical embodiment for an integrator unit 301 according to FIG. 3, two integrator rods 303 and 305 of calcium fluoride with the dimensions 35.5 mm×5.4 mm×250 mm are arranged one behind the other. Both integrator rods have the same dimensions. The crystallographic direction <100> in both integrator rods runs parallel to their longitudinal axes. Between the integrator rods 303 and 305, a half-wave plate 309 with a thickness of 20 μm is seamlessly inserted. The half-wave plate is oriented so that the slow axis of the calcium fluoride crystal stands at 45° to the edges of the rod-integrator cross-section. The half-wave plate 309 is made of magnesium fluoride.

In a further embodiment, the single half-wave plate 309 of FIG. 3 is replaced by a 90°-rotator consisting of two half-wave plates that are rotated by 45° relative to each other. The integrator unit comprises two integrator rods 303 and 305 of calcium fluoride with the dimensions 35.5 mm×5.4 mm×250 mm that are arranged one behind the other. Both integrator rods have the same dimensions. The crystallographic direction <100> in both integrator rods runs parallel to their longitudinal axes. Between the integrator rods 303 and 305, two thin half-wave plates of magnesium fluoride are arranged consecutively.

The following analysis is for a light ray traversing the integrator unit at an oblique angle. The path of the light ray starts at the center of the entry surface of the first integrator rod and has the direction (0.110, 0.0, 0.994). The Jones matrix for this light ray and for the integrator unit is

$$J = [ \begin{matrix}0.0004 exp ( i \cdot 171.3 ° \cdot \frac{2 π}{360 °} ) & 0.9070 exp ( i \cdot 354 ° \cdot \frac{2 π}{360 °} ) \\ 0.9070 exp ( i \cdot 173.9 ° \cdot \frac{2 π}{360 °} ) & 0.00046 exp ( i \cdot 176.6 ° \cdot \frac{2 π}{360 °} )\end{matrix} ]$$

The Jones matrix indicates that light with a (1, 0)-polarization at the starting point (Jones-vector

$$( \begin{matrix}1 \\ 0\end{matrix} ) )$$

remains more or less unaffected. The same applies to light with a linear (0, 1) polarization at the start (Jones-vector

$$( \begin{matrix}1 \\ 0\end{matrix} ) ) .$$

This can be concluded from the phase differences between the components of the Jones vectors after applying the Jones matrix, which in this case are close to 0° or 180°.

If one takes the 90°-rotator out of the integrator unit, light which had a (1, 0)- or (0, 1)-polarization at its entry into the rod is turned into elliptically polarized light. This can be concluded from the columns of the Jones matrix for the light ray in the now modified system:

$$J = [ \begin{matrix}0.9067 exp ( i \cdot 168.4 ° \cdot \frac{2 π}{360 °} ) & 0.0045 exp ( i \cdot 101.2 ° \cdot \frac{2 π}{360 °} ) \\ 0.0043 exp ( i \cdot 89.6 ° \cdot \frac{2 π}{360 °} ) & 0.90736 exp ( i \cdot 179.5 ° \cdot \frac{2 π}{360 °} )\end{matrix} ]$$

The phase difference between the matrix components after applying the Jones matrix J amounts in this case to about 80°. However the amplitude of one of the two components predominates, so that the ellipse that describes the state of polarization is quite flat.

In the arrangement of the two integrator rods that are separated by a 90°-rotator as described above, the Jones matrix J for a light ray traversing the system is composed of the matrix T₁ of the first integrator rod, the matrix R for the 90°-rotator, and the matrix T₂ for the second integrator rod. Based on the equal geometries and polarization properties of the integrator rods, the Jones matrices for the glass rods are nearly equal, due to reasons of symmetry based on the assumption that the light ray before and after the 90°-rotator traverses equal paths in equal directions through the material. For all possible light rays, this is largely the case. The compensation is achieved as a result of the 90°-rotator, which has the effect of exchanging the two mutually orthogonal states of polarization against each other.

In the case of stress-induced birefringence, the detrimental influence in an integrator unit may be compensated as follows:

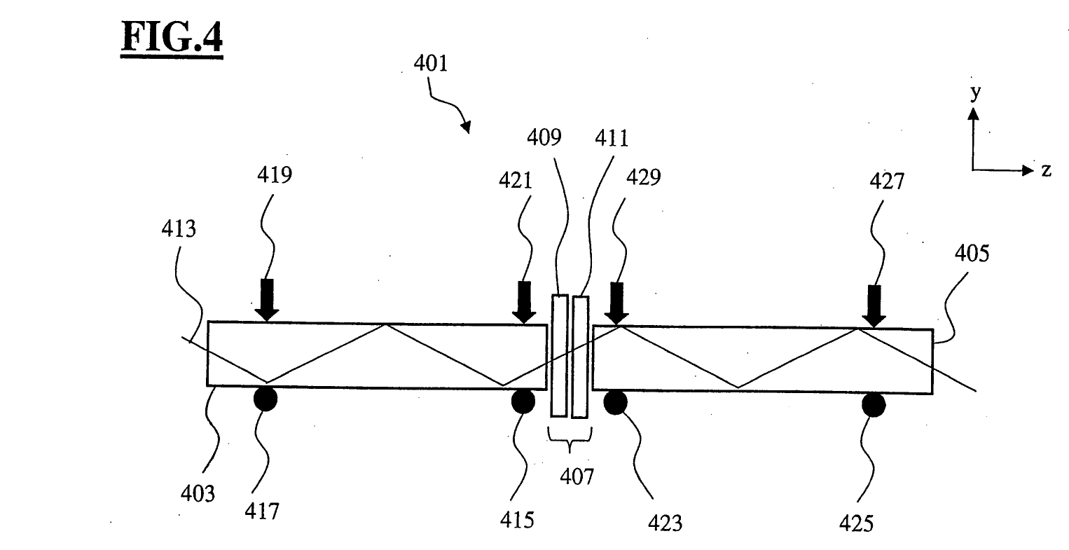

FIG. 4 shows a schematic representation of an integrator unit 401 consisting of a first integrator rod 403 and a second integrator rod 405. An optical retarding system 407 is arranged between the two integrator rods. The integrator rods 403 and 405 have the same dimensions, and their longitudinal axes are aligned in the z-direction. The cross-sectional dimensions extend in the x- and y-directions. The optical retarding system 407 consists of the two half-wave plates 409 and 411, whose fast axes are rotated by 45° relative to each other. The orientation of the fast axis of the half-wave plate 409 relative to the integrator rod is in this case of no concern. A light ray 413 is shown traversing the integrator unit 401. The integrator rod 403 is supported at the support points 415 and 417 and held by clamping devices 419 and 421. The integrator rod 405 is supported at the support points 423 and 425 and held by clamping devices 427 and 429. The support points 415 and 423 are at equidistant positions from the retarding system 407. The same applies, respectively, to the support points 417 and 425, the clamping devices 421 and 429, and the clamping devices 419 and 427. The mounting devices 415, 417, 419, 421, 423, 425, 427 and 429 cause stress-induced birefringence which has the effect of altering the state of polarization of the light ray 413. Inside the integrator rod 403, the ray 413 is subjected to an optical path difference ΔOPL₁, and inside the integrator rod 405 to an optical path difference ΔOPL₂. As the mounting devices are arranged symmetrically in relation to the retarding system 407, the amounts of the optical path differences between the two mutually orthogonal states of polarization E₁ and E₂ for the ray 413 are nearly equal in the two integrator rods 403 and 405, i.e., ΔOPL₁≈ΔOPL₂.

To control the stress-induced birefringence and to thereby compensate the undesirable birefringent effects, it is advantageous to provide a possibility for adjusting the clamping force of a clamping device. In the arrangement shown in FIG. 4, this adjustability is provided for the clamping devices 427 and 429.

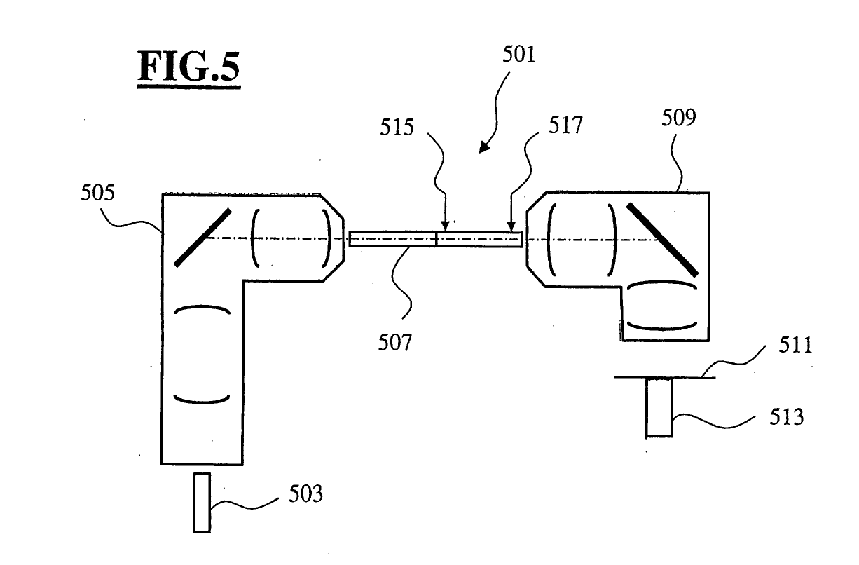

FIG. 5 represents a schematic view of an embodiment of an illumination system 501 for a microlithography projection apparatus. Among other possibilities, a DUV- or VUV laser can be used for the light source 503, for example an ArF laser for a wavelength of 193 nm or an F₂ laser for 157 nm, both of which generate linearly polarized light. A collector unit 505 focuses the light of the light source 503 onto the integrator unit 507, the latter being of the type discussed in the context of FIG. 4. The exit surface of the integrator unit 507 is projected through the so-called REMA objective 509 onto the reticle plane 511, which is where the so-called reticle, i.e. the mask carrying the structure, is located in a microlithography projection apparatus. An illumination system for this application is described in more detail in DE 195 48 805 A1 (U.S. Pat. No. 5,982,558). However, in the embodiment of FIG. 5, a polarization-measuring instrument 513 is arranged in the reticle plane 511, whereby the state of polarization can be determined at different points of the field. Using the measured values obtained from the polarization-measuring instrument 513, the adjustable clamping devices 515 and 517 are actuated in a controlled manner. By changing the magnitude of the clamping force between the support points and the application points of the clamping force, the stress-induced birefringence inside the second integrator rod, and thus the state of polarization of the rays, is altered. This makes it possible to control the state of polarization in the reticle plane 511.

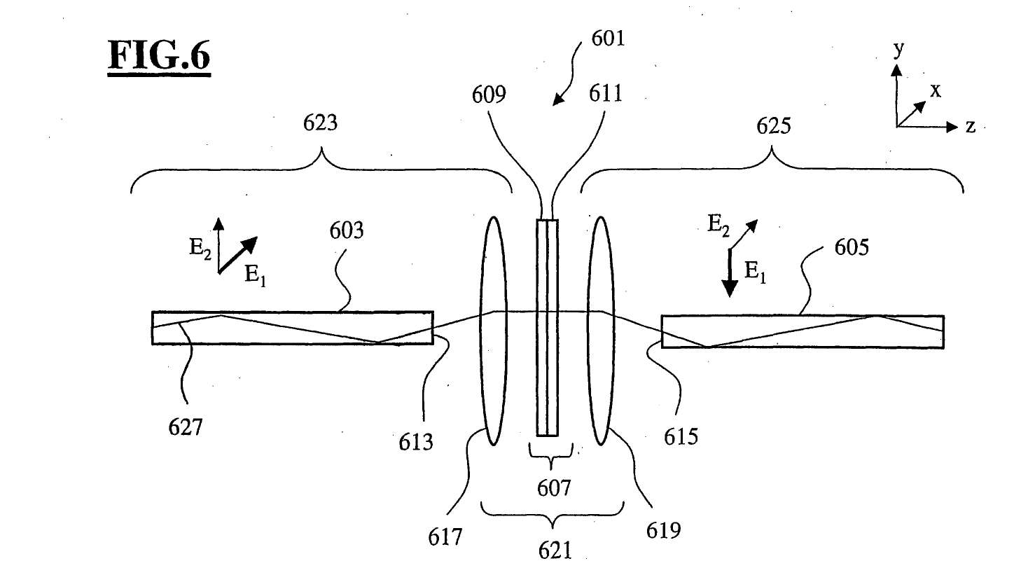

FIG. 6 shows a further embodiment of the invention in an integrator unit 601 in a schematic representation. The integrator unit 601 consists of the first optical subsystem 623 with the integrator rod 603 and the optical device portion 617, and the second optical subsystem 625 with the integrator rod 605 and the optical device portion 619. Arranged between the two optical subsystems 623, 625 is the optical retardation system 607. The two integrator rods 603 and 605 have identical dimensions. The longitudinal axes of the two integrator rods are aligned in the z-direction, and the cross-sectional planes extend in the x- and y-directions. The optical retardation system 607 consists of the two half-wave plates 609 and 611 whose fast axes are rotated by 45° in relation to each other. The exit surface 613 of the first integrator rod 603 is imaged onto the entry surface 615 of the second integrator rod 605 by means of the image-projecting system 621 that consists of the optical device portions 617 and 619 and the retardation system 607. This makes it possible to use half-wave plates of larger diameters. For a light ray 627 traveling in the plane of the drawing in FIG. 6, a first state of polarization E₁ and a second state of polarization E₂ that is orthogonal to E₁ are indicated once for the first integrator 603 and once for the second integrator 605. The retardation system 607 rotates the two states of polarization E₁ and E₂ by 90° and thereby effectively interchanges them with each other.

If the invention is to be applied to optical systems that consist of a multitude of optical elements with birefringent properties, one will first have to delimit the optical subsystems between which a retardation system, the so-called 90°-rotator, is to be arranged in order to achieve a substantial reduction of the undesirable influence of birefringence. The limits between the two optical subsystems can be determined in different ways. It is possible to use the aforementioned technique of computing the Jones matrix of the optical system through an optics software program such as CodeV® for all of the possible optical subsystems. Based on the results, one can select the partitioning of the system into the two subsystems in such a manner that the normalized Jones matrices of the selected optical subsystems are approximately equal. In the case of a projection objective, where the birefringent effect is caused primarily by the intrinsic birefringence of fluoride crystal lenses, a possible place for inserting the 90°-rotator can be determined by taking the thickness dimensions of the lenses and the maximum angles of incidence into account. It is typical for projection objectives that the lenses which cause large path differences for two mutually orthogonal states of polarization are located in the part of the objective that is closest to the image plane.

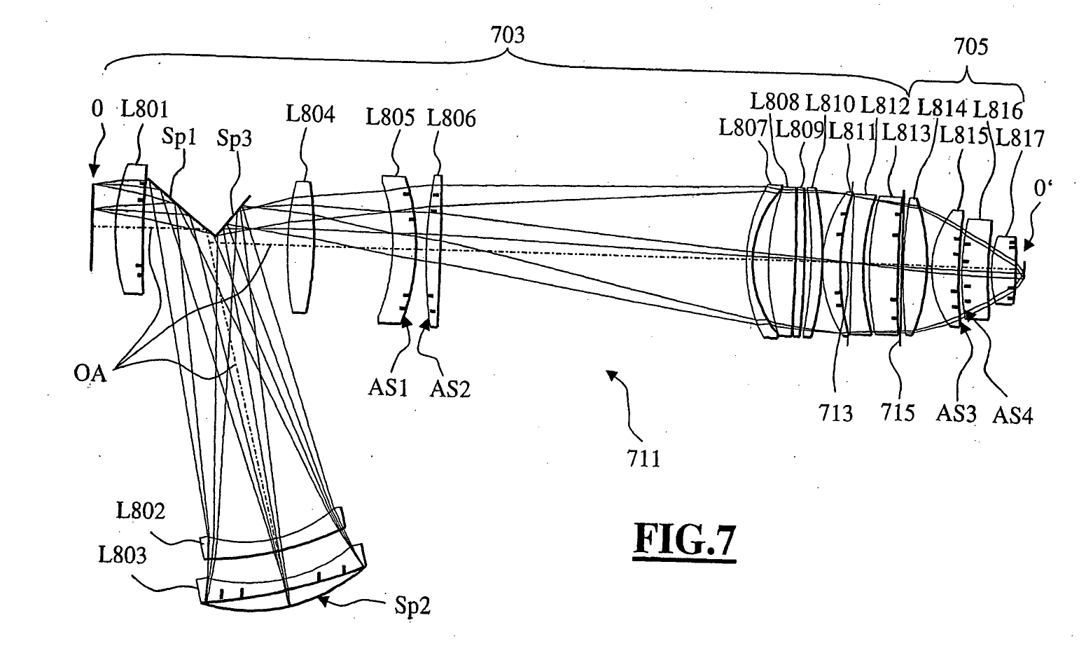

FIG. 7 represents a catadioptric projection objective 711 for a wavelength of 157 nm in the sectional plane containing the lens axes. The optical data for this objective are listed in Table 1. This embodiment has been taken from the patent application WO 0150171 A1 which was filed by the applicant. It corresponds to the example (U.S. Ser. No. 10/177,580) represented in FIG. 9 and Table 8 of WO 0150171 A1, which also contains a more detailed description of the function of the objective. All lenses of this objective consist of crystalline calcium fluoride. The lens axes of all lenses are oriented in the crystallographic direction <111>. The lenses are not rotated relative to each other. Therefore, the crystallographic orientations of all lenses are equivalent to each other. The numerical aperture on the image side of the objective is 0.8.

For the embodiment of FIG. 7, the illustration is based on light rays coming from an object point at the coordinates x=0 mm and y=−43.5 mm, with the origin of the coordinate system being located on the optical axis OA. The directions of the five light rays are listed in Table 2. Kₓ and K_{y} indicate the first two Cartesian components of the light-ray vector. The third component K_{z} can be determined from the other components based on the normalizing condition that each of the vectors is a unit vector (length 1.0). The light rays pass through the diaphragm plane 713 evenly distributed. Table 3 lists for some selected lenses the cumulative optical path difference of a light ray for two mutually orthogonal states of polarization in nm units after the ray has traveled through the objective 711 from the object plane O to the selected lens. The columns of Table 3 that apply to the non-compensated system show a particularly strong unwanted birefringent effect of the last four lenses L814 to L817. It would therefore be beneficial to place the retarding system 715, hereinafter referred to as a 90°-rotator between the lenses L813 and L814. The 90°-retarder 715 can be obtained by combining two half-wave plates whose fast axes enclose an angle of 45° relative to each other. Alternatively it is possible to coat the two surfaces of the lenses L813 and L814 facing each other with special coatings which are each designed to produce an effect corresponding to a half-wave plate. The first optical subsystem 703 is thus made up of the lenses L801 to L813 as well as the mirrors Sp1 to Sp3. The second optical subsystem 705 is composed of the lenses L814 to L817. The lenses L812 and L813 are positioned between the 90°-rotator and the diaphragm plane 713. An optimal position for the 90°-rotator would be within the lens L814. This could be taken into account in the design process by splitting the lens L814 in order to optimize the compensation. Alternatively it is possible to coat the two surfaces of lens L814, the front surface and the rear surface, with special coatings which are each designed to produce an effect corresponding to a half-wave plate.

As an example, the Jones matrix T₁ for ray 2 of Table 2 is evaluated below. The first optical subsystem 703 has a normalized Jones matrix T₁ and a determinant D₁ of the Jones matrix before the latter has been normalized.

$${T}_{1} = [ \begin{matrix}0.87 exp ( - 2 π i 0.09 ) & 0.49 exp ( 2 π i 0.19 ) \\ 0.49 exp ( 2 π i 0.31 ) & 0.87 exp ( 2 π i 0.09 )\end{matrix} ] and {D}_{1} = 0.99$$

The second optical subsystem 705 has for the same light ray a normalized Jones matrix T₂ and a determinant D₂ of the Jones matrix before the latter has been normalized.

$${T}_{2} = [ \begin{matrix}0.87 exp ( - 2 π ⅈ 0.1 ) & 0.49 exp ( 2 π ⅈ 0.27 ) \\ 0.49 exp ( 2 π ⅈ 0.23 ) & 0.87 exp ( 2 π ⅈ 0.1 )\end{matrix} ] \qquad and \qquad {D}_{2} = 0.88$$

Table 4 illustrates that the optical path difference in all light rays is reduced to 40%, and in some cases to less than 10% of the value observed in an objective 711 that is not equipped with the retardation system 715. Thus, the invention leads to a decisive improvement of the optical qualities of the projection objective.

TABLE 2

| | Kₓ | K_{y} |
|---|---|---|
| Ray 1 | 0 | −0.10483 |
| Ray 2 | −0.1056 | 0.05005 |
| Ray 3 | 0 | 0.05005 |
| Ray 4 | 0.1056 | 0.10637 |
| Ray 5 | 0.1056 | 0.05005 |

TABLE 3

| | Ray 1 | | Ray 2 | | Ray 3 | | Ray 4 | | Ray 5 | |
|---|---|---|---|---|---|---|---|---|---|---|
| | w/o 715 | with 715 | w/o 715 | with 715 | w/o 715 | with 715 | w/o 715 | with 715 | w/o 715 | with 715 |
| Lens | [nm] | [nm] | [nm] | [nm] | [nm] | [nm] | [nm] | [nm] | [nm] | [nm] |
| L809 | 17.14 | 17.14 | 20.85 | 20.85 | 11.97 | 11.97 | 32.13 | 32.13 | 20.86 | 20.86 |
| L811 | 18.43 | 18.43 | 24.42 | 24.42 | 20.03 | 20.03 | 35.60 | 35.60 | 24.43 | 24.43 |
| L813 | 23.07 | 23.07 | 35.48 | 35.48 | 32.31 | 32.31 | 51.23 | 51.23 | 35.48 | 35.48 |
| L814 | 25.45 | 19.94 | 40.68 | 29.59 | 39.67 | 24.73 | 55.83 | 45.11 | 40.68 | 29.59 |
| L815 | 36.39 | 8.71 | 52.68 | 17.44 | 54.01 | 10.18 | 65.85 | 32.07 | 52.68 | 17.45 |
| L817 | 62.54 | 5.06 | 76.92 | 3.40 | 76.03 | 4.33 | 46.33 | 16.41 | 76.92 | 3.41 |

Table 3 demonstrates that for all light rays, the optical path difference is reduced to 40%, and in most cases to less than 10% of the value observed in a system that is not equipped with a 90°-rotator. Thus, the invention leads to a decisive improvement of the optical qualities of the projection objective.

TABLE 4

| | Ray 1 | Ray 2 | Ray 3 | Ray 4 | Ray 5 |
|---|---|---|---|---|---|
| ΔOPL₁ Subsystem 703 | 23.07 | 35.48 | 32.31 | 51.23 | 35.48 |
| [nm] | | | | | |
| ΔOPL₂ Subsystem 705 | −18.01 | −32.08 | −27.98 | −34.81 | −32.08 |
| [nm] | | | | | |
| Difference | 5.06 | 3.40 | 4.33 | 16.41 | 3.41 |
| [nm] | | | | | |

Table 4 lists the respective optical path differences ΔOPL₁ and ΔOPL₂ for each of the four light rays in the first optical subsystem 703 and the second optical subsystem 705.

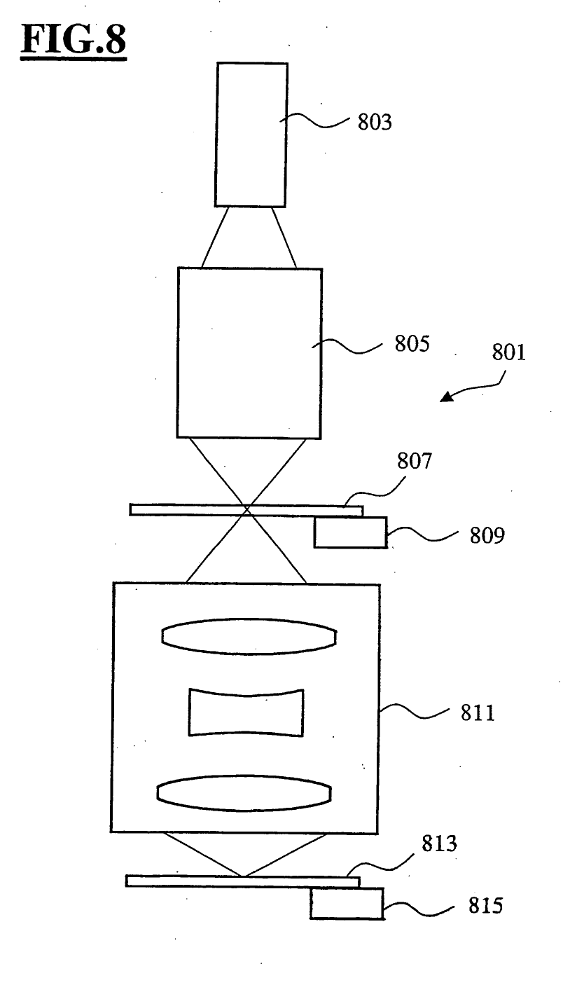

FIG. 8 illustrates the principal arrangement of a projection apparatus 801. The projection apparatus 801 comprises a light source 803, an illumination system 805, a reticle 807, a reticle support unit 809, a projection objective 811, a light sensitive substrate 813 and a support unit 815 for the substrate 813. The illumination system 805 is exemplified by the embodiment of FIG. 5. The illumination system 805 collects light of the light source 803 and illuminates an area in the object plane of the projection objective 811. The reticle 807 which is positioned in the light path by means of the reticle support unit 809 is arranged in the object plane of the projection objective 811. The reticle 807 of the kind that is used in microlithography has a structure with detail dimensions in the range of micrometers and nanometers. The reticle 807 can be e.g. a structured mask, a programmable mirror array or a programmable LCD array. The structure of the reticle 807 or a part of this structure is projected by means of the projection objective 811 onto the light-sensitive substrate 813, which is arranged in the image plane of the projection objective 811. The projection objective 811 is exemplified by the embodiment of FIG. 7. The light-sensitive substrate 813 is held in position by the wafer support unit 815. The light-sensitive substrate 813 is typically a silicon wafer that has been coated with a layer of a radiation sensitive material, the resist.

The projection apparatus 801 can be used, for example, in the manufacture of microstructured devices such as integrated circuits. In such a case the reticle 807 may generate a circuit pattern corresponding to an individual layer of the integrated circuit. This circuit pattern can be imaged onto the light-sensitive substrate 813.

The minimum size of the structural details that can be resolved in the projection depends on the wavelength λ of the light used for illumination, and also on the numerical aperture on the image side of the projection objective 811. With the embodiment shown in FIG. 7, it is possible to realize resolution levels finer than 150 nm. Because of the fine resolution desired, it is necessary to minimize effects such as birefringence. The present invention represents a successful solution to strongly reduce the detrimental influence of birefringence particularly in projection objectives with a large numerical aperture on the image side.

TABLE 1

| | | | | REFR. INDEX | ½ FREE |
|---|---|---|---|---|---|
| LENSES | RADII | THICKNESSES | MATERIALS | AT 157.13 nm | DIAMETER |
| 0 | 0.000000000 | 34.000000000 | | 1.00000000 | 82.150 |
| | 0.000000000 | 0.100000000 | | 1.00000000 | 87.654 |
| L801 | 276.724757380 | 40.000000000 | CaF2 | 1.55970990 | 90.112 |
| | 1413.944109416AS | 95.000000000 | | 1.00000000 | 89.442 |
| SP1 | 0.000000000 | 11.000000000 | | 1.00000000 | 90.034 |
| | 0.000000000 | 433.237005445 | | 1.00000000 | 90.104 |
| L802 | −195.924336384 | 17.295305525 | CaF2 | 1.55970990 | 92.746 |
| | −467.658808527 | 40.841112468 | | 1.00000000 | 98.732 |
| L803 | −241.385736441 | 15.977235467 | CaF2 | 1.55970990 | 105.512 |
| | −857.211727400AS | 21.649331094 | | 1.00000000 | 118.786 |
| SP2 | 0.000000000 | 0.000010000 | | 1.00000000 | 139.325 |
| | 253.074839896 | 21.649331094 | | 1.00000000 | 119.350 |
| L803′ | 857.211727400AS | 15.977235467 | CaF2 | 1.55970990 | 118.986 |
| | 241.385736441 | 40.841112468 | | 1.00000000 | 108.546 |
| L802′ | 467.658808527 | 17.295305525 | CaF2 | 1.55970990 | 102.615 |
| | 195.924336384 | 419.981357165 | | 1.00000000 | 95.689 |
| SP3 | 0.000000000 | 6.255658280 | | 1.00000000 | 76.370 |
| | 0.000000000 | 42.609155219 | | 1.00000000 | 76.064 |
| Z1 | 0.000000000 | 67.449547115 | | 1.00000000 | 73.981 |
| L804 | 432.544479547 | 37.784311058 | CaF2 | 1.55970990 | 90.274 |
| | −522.188532471 | 113.756133662 | | 1.00000000 | 92.507 |
| L805 | −263.167605725 | 33.768525968 | CaF2 | 1.55970990 | 100.053 |
| | −291.940616829AS | 14.536591424 | | 1.00000000 | 106.516 |
| L806 | 589.642961222AS | 20.449887046 | CaF2 | 1.55970990 | 110.482 |
| | −5539.698828792 | 443.944079795 | | 1.00000000 | 110.523 |
| L807 | 221.780582003 | 9.000000000 | CaF2 | 1.55970990 | 108.311 |
| | 153.071443064 | 22.790060084 | | 1.00000000 | 104.062 |
| L808 | 309.446967518 | 38.542735318 | CaF2 | 1.55970990 | 104.062 |
| | −2660.227900099 | 0.100022286 | | 1.00000000 | 104.098 |
| L809 | 23655.354584194 | 12.899131182 | CaF2 | 1.55970990 | 104.054 |
| | −1473.189213176 | 9.318886362 | | 1.00000000 | 103.931 |
| L810 | −652.136459374 | 16.359499814 | CaF2 | 1.55970990 | 103.644 |
| | −446.489459129 | 0.100000000 | | 1.00000000 | 103.877 |
| L811 | 174.593507050 | 25.900313780 | CaF2 | 1.55970990 | 99.267 |
| | 392.239615259AS | 14.064505431 | | 1.00000000 | 96.610 |
| | 0.000000000 | 2.045119392 | | 1.00000000 | 96.552 |
| L812 | 7497.306838492 | 16.759051656 | CaF2 | 1.55970990 | 96.383 |
| | 318.210831711 | 8.891640764 | | 1.00000000 | 94.998 |
| L813 | 428.724465129 | 41.295806263 | CaF2 | 1.55970990 | 95.548 |
| | 3290.097860119AS | 7.377912006 | | 1.00000000 | 95.040 |
| L814 | 721.012739719 | 33.927118706 | CaF2 | 1.55970990 | 95.443 |
| | −272.650872353 | 6.871397517 | | 1.00000000 | 95.207 |
| L815 | 131.257556743 | 38.826450065 | CaF2 | 1.55970990 | 81.345 |
| | 632.112566477AS | 4.409527396 | | 1.00000000 | 74.847 |
| L816 | 342.127616157AS | 37.346293509 | CaF2 | 1.55970990 | 70.394 |
| | 449.261078744 | 4.859754445 | | 1.00000000 | 54.895 |
| L817 | 144.034814702 | 34.792179308 | CaF2 | 1.55970990 | 48.040 |
| | −751.263321098AS | 11.999872684 | | 1.00000000 | 33.475 |
| 0′ | 0.000000000 | 0.000127776 | | 1.00000000 | 16.430 |

| Asphere of Lens L801 | | Asphere of Lens L803 | | Asphere of Lens L803 | |
|---|---|---|---|---|---|
| K | 0.0000 | K | 0.0000 | K | 0.0000 |
| C1 | 4.90231706e−009 | C1 | −5.33460884e−009 | C1 | 5.33460884e−009 |
| C2 | 3.08634889e−014 | C2 | 9.73867225e−014 | C2 | −9.73867225e−014 |
| C3 | −9.53005325e−019 | C3 | −3.28422058e−018 | C3 | 3.28422058e−018 |
| C4 | −6.06316417e−024 | C4 | 1.50550421e−022 | C4 | −1.50550421e−022 |
| C5 | 6.11462814e−028 | C5 | 0.00000000e+000 | C5 | 0.00000000e+000 |
| C6 | −8.64346302e−032 | C6 | 0.00000000e+000 | C6 | 0.00000000e+000 |
| C7 | 0.00000000e+000 | C7 | 0.00000000e+000 | C7 | 0.00000000e+000 |
| C8 | 0.00000000e+000 | C8 | 0.00000000e+000 | C8 | 0.00000000e+000 |
| C9 | 0.00000000e+000 | C9 | 0.00000000e+000 | C9 | 0.00000000e+000 |
| Asphere of Lens L805 | | Asphere of Lens L806 | | Asphere of Lens L811 | |
| K | 0.0000 | K | 0.0000 | K | 0.0000 |
| C1 | 2.42569449e−009 | C1 | −6.74111232e−009 | C1 | 2.28889624e−008 |
| C2 | 3.96137865e−014 | C2 | −2.57289693e−014 | C2 | −1.88390559e−014 |
| C3 | −2.47855149e−018 | C3 | −2.81309020e−018 | C3 | 2.86010656e−017 |
| C4 | 7.95092779e−023 | C4 | 6.70057831e−023 | C4 | −3.18575336e−021 |
| C5 | 0.00000000e+000 | C5 | 5.06272344e−028 | C5 | 1.45886017e−025 |
| C6 | 0.00000000e+000 | C6 | −4.81282974e−032 | C6 | −1.08492931e−029 |
| C7 | 0.00000000e+000 | C7 | 0.00000000e+000 | C7 | 0.00000000e+000 |
| C8 | 0.00000000e+000 | C8 | 0.00000000e+000 | C8 | 0.00000000e+000 |
| C9 | 0.00000000e+000 | C9 | 0.00000000e+000 | C9 | 0.00000000e+000 |
| Asphere of Lens L813 | | Asphere of Lens L815 | | Asphere of Lens L816 | |
| K | 0.0000 | K | 0.0000 | K | 0.0000 |
| C1 | 3.40212872e−008 | C1 | −3.15395039e−008 | C1 | −2.16574623e−008 |
| C2 | −1.08008877e−012 | C2 | 4.30010133e−012 | C2 | −6.67182801e−013 |
| C3 | 4.33814531e−017 | C3 | 3.11663337e−016 | C3 | 4.46519932e−016 |
| C4 | −7.40125614e−021 | C4 | −3.64089769e−020 | C4 | −3.71571535e−020 |
| C5 | 5.66856812e−025 | C5 | 1.06073268e−024 | C5 | 0.00000000e+000 |
| C6 | 0.00000000e+000 | C6 | 0.00000000e+000 | C6 | 0.00000000e+000 |
| C7 | 0.00000000e+000 | C7 | 0.00000000e+000 | C7 | 0.00000000e+000 |
| C8 | 0.00000000e+000 | C8 | 0.00000000e+000 | C8 | 0.00000000e+000 |
| C9 | 0.00000000e+000 | C9 | 0.00000000e+000 | C9 | 0.00000000e+000 |

Asphere of Lens L817

| | |
|---|---|
| K | 0.0000 |
| C1 | 2.15121397e−008 |
| C2 | −1.65301726e−011 |
| C3 | −5.03883747e−015 |
| C4 | 1.03441815e−017 |
| C5 | −6.29122773e−021 |
| C6 | 1.44097714e−024 |
| C7 | 0.00000000e+000 |
| C8 | 0.00000000e+000 |
| C9 | 0.00000000e+000 |

1. An optical system
with a first optical subsystem comprising at least one first birefringent optical element,
with a second optical subsystem comprising at least one second birefringent optical element,
wherein an optical retarding system with at least a first optical retarding element is arranged between the first optical subsystem and the second optical subsystem, said first optical retarding element introducing a retardation of one-half of a wavelength between two mutually orthogonal states of polarization.

2. The optical system according to claim 1,
wherein the optical retarding system comprises a second optical retarding element, said second optical retarding element introducing a retardation of one-half of a wavelength between two mutually orthogonal states of polarization,
wherein the first optical retarding element has a first fast axis and the second optical retarding element has a second fast axis, and
wherein the first fast axis and the second fast axis enclose between each other an angle of 45° within a tolerance of ±100.

3. The optical system according to claim 2, wherein said angle is 45° within a tolerance of ±50.

4. The optical system according to claim 1,
wherein a light ray travels through the optical system,
wherein inside the first optical subsystem, the light ray is subjected to a first optical path difference ΔOPL₁ for two mutually orthogonal states of polarization,
wherein inside the second optical subsystem, the light ray is subjected to a second optical path difference ΔOPL₂ for two mutually orthogonal states of polarization, and
wherein the absolute value of the first optical path difference ΔOPL₁ differs from the absolute value of the second optical path difference ΔOPL₂ by no more than 40%.

5. The optical system according to claim 1, wherein the absolute value of the first optical path difference ΔOPL₁ differs from the absolute value of the second optical path difference ΔOPL₂ by no more than 30%.

6. The optical system according to claim 1,
wherein a light ray travels through the optical system,
wherein the first optical subsystem acts on the light ray with a first normalized Jones matrix T₁ with the coefficients T_{1,xx}, T_{1,xy}, T_{1,yx} und T_{1,yy}:
$${T}_{1} = ( \begin{matrix}{T}_{1 , xx} & {T}_{1 , xy} \\ {T}_{1 , yx} & {T}_{1 , yy}\end{matrix} ) ,$$
wherein the second optical subsystem acts on the light ray with a second normalized Jones matrix T₂ with the coefficients T_{2,xx}, T_{2,xy}, T_{2,yx} and T_{2,yy}:
$${T}_{2} = ( \begin{matrix}{T}_{2 , xx} & {T}_{2 , xy} \\ {T}_{2 , yx} & {T}_{2 , yy}\end{matrix} ) ,$$
and
wherein the absolute values of the coefficients of the first normalized Jones matrix T₁ deviate from the absolute values of the corresponding coefficients of the second normalized Jones matrix T₂ by no more than 30%.

7. The optical system according to claim 6, wherein the absolute values of the coefficients of the first normalized Jones matrix T₁ deviate from the absolute values of the corresponding coefficients of the second normalized Jones matrix T₂ by no more than 20%.

8. The optical system according to claim 1, wherein a bundle of light rays travels through the system, with each of the rays of the bundle having an optical path difference ΔOPL for two mutually orthogonal states of polarization, and
wherein the distribution of the optical path differences ΔOPL of the bundle of light rays has significantly reduced values of the optical path differences in comparison to an optical system without the retarding system.

9. The optical system according to claim 1, wherein the first birefringent optical element is a first birefringent integrator rod, and
wherein the second birefringent optical element is a second birefringent integrator rod.

10. The optical system according to claim 9, wherein the first birefringent integrator rod and the second birefringent integrator rod have nearly identical dimensions.

11. The optical system according to claim 9,
wherein the first integrator rod has a longitudinal axis and consists of a fluoride crystal, wherein a principal crystallographic direction of the fluoride crystal runs in the direction of the longitudinal axis of the first integrator rod, and
wherein the second integrator rod has a longitudinal axis and consists of a fluoride crystal, wherein a principal crystallographic direction of the fluoride crystal runs in the direction of the longitudinal axis of the second integrator rod.

12. The optical system according to claim 11, wherein at least one of said principal crystallographic direction in the first integrator rod and said principal crystallographic direction in the second integrator rod is the crystallographic <100>-direction.

13. The optical system according to claim 9,
wherein the first integrator rod has a first mounting device,
wherein the second integrator rod has a second mounting device, and
wherein the distance of the first mounting device from the optical retarding system differs from the distance of the second mounting device from the optical retarding system by no more than 20%.

14. The optical system according to claim 9,
wherein at least one of the first integrator rod and the second integrator rod has a clamping device with a variable clamping force.

15. The optical system according to claim 9, wherein the optical retarding system consists of only the first optical retarding element, and wherein the first fast axis encloses an angle of nearly 45° with an edge of a surface of one of the first integrator rod and the second integrator rod, said surface facing the optical retarding system.

16. The optical system according to claim 9, wherein the first optical subsystem comprises a first optical device portion,
wherein the second optical subsystem comprises a second optical device portion, and
wherein the first optical device portion and the second optical device portion project an image of the surface of the first integrator rod that faces the optical retarding system onto the surface of the second integrator rod that faces the optical retarding system.

17. An illumination system for a projection apparatus with an optical system according to claim 9.

18. The optical system according to claim 1, wherein the optical system is one of:
a projection objective for a projection apparatus, said projection objective projecting an image of an object plane onto an image plane, and
a partial objective of said objective.

19. The optical system according to claim 18, further comprising a diaphragm plane,
wherein from an object point in the object plane, a bundle of light rays emanates, said light rays traversing the diaphragm plane evenly distributed, wherein in the first optical subsystem, said light rays are subjected to first optical path differences ΔOPL₁ for two mutually orthogonal states of polarization, and in the second optical subsystem, said light rays are subjected to second optical path differences ΔOPL₂ for two mutually orthogonal states of polarization, and
wherein a maximum absolute value of the distribution function of the first optical path differences ΔOPL₁ differs from a maximum absolute value of the distribution function of the second optical path differences ΔOPL₂ by no more than 40%.

20. The optical system according to claim 19, wherein said maximum absolute value of the distribution function of the first optical path differences ΔOPL₁ differs from said maximum absolute value of the distribution function of the second optical path differences ΔOPL₂ by no more than 30%.

21. The optical system according to claim 18, further comprising a diaphragm plane,
wherein from an object point in the object plane, a bundle of light rays emanates, said light rays traversing the diaphragm plane evenly distributed, said light rays being acted on in the first optical subsystem by first normalized Jones matrices T₁ with the coefficients T_{1,xx}, T_{1,xy}, T_{1,yx} and T_{1,yy}:
$${T}_{1} = ( \begin{matrix}{T}_{1 , xx} & {T}_{1 , xy} \\ {T}_{1 , yx} & {T}_{1 , yy}\end{matrix} ) ,$$
said light rays being acted on in the second optical subsystem by second normalized Jones matrices T₂ with the coefficients T_{2,xx}, T_{2,xy}, T_{2,yx} and T_{2,yy}:
$${T}_{2} = ( \begin{matrix}{T}_{2 , xx} & {T}_{2 , xy} \\ {T}_{2 , yx} & {T}_{2 , yy}\end{matrix} ) ,$$
and
wherein the maximum of the differences between the absolute values of the coefficients of the first normalized Jones matrices T₁ and the absolute values of the corresponding coefficients of the second normalized Jones matrices T₂ for each light ray of the bundle is less than 30% of the maximum value of the absolute values of the coefficients of the first normalized Jones matrices T₁.

22. The optical system according to claim 21, wherein the maximum of the differences between the absolute values of the coefficients of the first normalized Jones matrices Tj and the absolute values of the corresponding coefficients of the second normalized Jones matrices T₂ for each light ray of the bundle is less than 20% of the maximum value of the absolute values of the coefficients of the first normalized Jones matrices T₁.

23. The optical system according to claim 18,
wherein the first birefringent optical element is a first lens consisting of a fluoride crystal and having a lens axis, wherein one principal crystallographic direction of the fluoride crystal runs in the direction of the lens axis, and
wherein the second birefringent optical element is a second lens consisting of a fluoride crystal and having a lens axis, wherein one principal crystallographic direction of the fluoride crystal runs in the direction of the lens axis.

24. The optical system according to claim 23,
wherein the first lens and the second lens consist of the same fluoride crystal material
and wherein the first lens and the second lens have equivalent crystallographic orientations.

25. The optical system according to claim 18,
wherein at least one optical retarding element is realized as a birefringent coating on an optical element.

26. The optical system according to claim 18, wherein the optical element on which the birefringent coating is realized is a lens.

27. The optical system according to claim 25,
wherein one of the first optical subsystem and the second optical subsystem comprises the optical element carrying the birefringent coating.

28. The optical system according to claim 18, further comprising a diaphragm plane, wherein the numerical aperture on the image side of the optical system is larger than the numerical aperture on the object side, and wherein the optical retarding system is arranged between the diaphragm plane and the image plane.

29. The optical system according to claim 28, wherein at least one optical element is arranged between the diaphragm plane and the optical retarding system.

30. A method of producing an optical system in which the birefringence is substantially compensated,
wherein the optical system consists of n optical elements, n being an integer that is equal to or larger than 2,
wherein the n optical elements comprise at least a first birefringent optical element and at least a second birefringent optical element,
wherein the method comprises the following steps:
A: setting up a first optical subsystem of m consecutively adjacent optical elements, where m is less than n;
B: setting up a second optical subsystem of n−m consecutively adjacent optical elements;
C: calculating the first normalized Jones matrix T₁ for the first optical subsystem with the coefficients T_{1,xx}, T_{1,xy}, T_{1,yx}, and T_{1,yy} describing the effect of the first optical subsystem on a light ray traveling through the optical system;
D: calculating the second normalized Jones matrix T₂ for the second optical subsystem with the coefficients T_{2,xx}, T_{2,xy}, T_{2,yx}, and T_{2,yy} describing the effect of the second optical subsystem on the same light ray;
E: calculating the differences ΔTₓₓ, ΔT_{xy}, ΔT_{yx}, and ΔT_{yy} between the absolute values of the corresponding coefficients;
F: repeating the steps A through E for all values of m between 1 and n−1;
G: determining the value m₀ for which the values of the differences ΔTₓₓ, ΔT_{xy}, ΔT_{yx}, and ΔT_{yy} are minimal;
H: inserting an optical retarding system between the first optical subsystem of m₀ consecutively adjacent optical elements and the second optical subsystem of n−m₀ consecutively adjacent optical elements, where the optical retarding system has at least a first optical retarding element introducing a retardation of one-half of a wavelength between two mutually orthogonal states of polarization.

31. The method according to claim 30, wherein the calculation in steps C and D is performed for a plurality of light rays.

32. An optical system made by a method according to claim 30.

33. A method of producing an optical system in which the birefringence is substantially compensated,
wherein the optical system consists of n optical elements, n being an integer that is equal to or larger than 2,
wherein the n optical elements comprise at least a first birefringent optical element and at least a second birefringent optical element,
wherein the method comprises the following steps:
A: setting up a first optical subsystem of m consecutively adjacent optical elements, where m is less than n;
B: setting up a second optical subsystem of n−m consecutively adjacent optical elements;
C: determining a first optical path difference ΔOPL₁ for two mutually orthogonal states of polarization for a light ray traveling through the optical system, wherein the light ray is subjected to said first optical path difference ΔOPL₁ inside the first optical subsystem;
D: determining a second optical path difference ΔOPL₂ for two mutually orthogonal states of polarization for the same light ray, wherein the light ray is subjected to said second optical path difference ΔOPL₂ inside the second optical subsystem;
E: calculating the difference ΔOPL between the absolute value of the first optical path difference ΔOPL₁ and the absolute value of the second optical path difference ΔOPL₂;
F: repeating the steps A through E for all values of m between 1 and n−1;
G: determining the value m₀ for which the value of the difference ΔOPL is minimal;
H: inserting an optical retarding system between the first optical subsystem of m₀ consecutively adjacent optical elements and the second optical subsystem of n−m₀ consecutively adjacent optical elements, where the optical retarding system has at least a first optical retarding element introducing a retardation of one-half of a wavelength between two mutually orthogonal states of polarization.

34. The method according to claim 33, wherein the calculation in steps C and D is performed for a plurality of light rays.

35. An optical system made by a method according to claim 33.

36. A method of producing an optical system in which the birefringence is substantially compensated,
wherein the optical system consists of n optical elements, n being a number that is equal to or larger than 2,
wherein the n optical elements comprise at least a first birefringent optical element and at least a second birefringent optical element,
wherein the method comprises the following steps:
A: setting up a first optical subsystem of m consecutively adjacent optical elements, where m is less than n, and where the m optical elements include the first birefringent optical element;
B: setting up a second optical subsystem of n−m consecutively adjacent optical elements, where the n−m optical elements include the second birefringent optical element;
C: calculating the first normalized Jones matrix T₁ for the first optical subsystem with the coefficients T_{1,xx}, T_{1,xy}, T_{1,yx}, and T_{1,yy}, describing the effect of the first optical subsystem on a light ray traveling through the optical system;
D: calculating the second normalized Jones matrix T₂ for the second optical subsystem with the coefficients T_{2,xx}, T_{2,xy}, T_{2,yx}, and T_{2,yy} describing the effect of the second optical subsystem on the same light ray;
E: calculating the differences ΔTₓₓ, ΔT_{xy}, ΔT_{yx}, and ΔT_{yy} between the values of the corresponding coefficients;
F: if one of the differences exceeds a prescribed threshold value, determining a new starting value m and repeating steps A through E; else, if all differences are below the prescribed threshold value, continue with G: inserting an optical retarding system between the first optical subsystem of m=m₀ consecutively adjacent optical elements and the second optical subsystem of n−m₀ consecutively adjacent optical elements, where the optical retarding system has at least a first optical retarding element introducing a retardation of one-half of a wavelength between two mutually orthogonal states of polarization.

37. The method according to claim 36, wherein the calculation in steps C and D is performed for a plurality of light rays.

38. An optical system made by a method according to claim 36.

39. A method of producing an optical system in which the birefringence is substantially compensated,
wherein the optical system consists of n optical elements, n being an integer that is equal to or larger than 2,
wherein the n optical elements comprise at least a first birefringent optical element and at least a second birefringent optical element,
wherein the method comprises the following steps:
A: setting up a first optical subsystem of m consecutively adjacent optical elements, where m is less than n, and where the m optical elements include the first birefringent optical element;
B: setting up a second optical subsystem of n−m consecutively adjacent optical elements, where the n−m optical elements include the second birefringent optical element;
C: determining a first optical path difference ΔOPL₁ for two mutually orthogonal states of polarization for a light ray traveling through the optical system, wherein the light ray is subjected to said first optical path difference ΔOPL₁ inside the first optical subsystem;
D: determining a second optical path difference ΔOPL₂ for two mutually orthogonal states of polarization for the same light ray, wherein the light ray is subjected to said second optical path difference ΔOPL₂ inside the second optical subsystem;
E: calculating the difference ΔOPL between the absolute value of the first optical path difference ΔOPL₁ and the absolute value of the second optical path difference ΔOPL₂;
F: if the difference ΔOPL exceeds a prescribed threshold value, repeating the steps A through E; else, if the difference ΔOPL is below the prescribed threshold value, continue with
G: inserting an optical retarding system between the first optical subsystem of m₀ consecutively adjacent optical elements and the second optical subsystem of n−m₀ consecutively adjacent optical elements, where the optical retarding system has at least a first optical retarding element introducing a retardation of one-half of a wavelength between two mutually orthogonal states of polarization.

40. The method according to claim 39, wherein the calculation in steps C and D is performed for a plurality of light rays.

41. An optical system made by a method according to claim 39.

42. Projection apparatus with an illumination system and a projection objective, wherein the illumination system illuminates an object plane of the projection objective, wherein said object plane is projected by means of the projection objective onto an image plane of the projection objective, and wherein the illumination system is an optical system according to claim 9.

43. Projection apparatus with an illumination system and a projection objective, wherein the illumination system illuminates an object plane of the projection objective, wherein said object plane is projected by means of the projection objective onto an image plane of the projection objective, and wherein the projection objective is an optical system according to claim 18.

44. Projection apparatus with an illumination system and a projection objective, wherein the illumination system illuminates an object plane of the projection objective, wherein said object plane is projected by means of the projection objective onto an image plane of the projection objective, and wherein the projection objective is an optical system according to claim 41.

45. The projection apparatus according to claim 42, wherein the projection objective is an optical system according to claim 18.

46. The projection apparatus according to claim 42, wherein the projection objective is an optical system according to claim 40.

47. The projection objective according to claim 43, wherein the illumination system is an optical system according to claim 9.

48. The projection objective according to claim 44, wherein the illumination system is an optical system according to claim 9.

49. A method of producing microstructured devices by lithography, wherein the method includes the step of using the projection apparatus according to claim 42.

50. A method of producing microstructured devices by lithography, wherein the method includes the step of using the projection apparatus according to claim 43.

51. A method of producing microstructured devices by lithography, wherein the method includes the step of using the projection apparatus according to claim 44.
